(19) United States
(12) Patent Application Publication
(10) Pub. No.: US 2017/0197615 A1
(43) Pub. Date: Jul. 13, 2017

(54) SYSTEM AND METHOD FOR REVERSE PERPENDICULAR PARKING A VEHICLE

(71) Applicant: Ford Global Technologies, LLC, Dearborn, MI (US)

(72) Inventors: Larry Dean ELIE, Ypsilanti, MI (US); Douglas Scott RHODE, Farmington Hills, MI (US)

(21) Appl. No.: 14/992,609

(22) Filed: Jan. 11, 2016

(51) Int. Cl. B60W 30/06; B62D 15/02; B60W 10/20

(52) U.S. Cl. CPC B60W 30/06; B60W 10/20; B62D 15/0285; B60W 2420/42; B60W 2710/20; B60W 2510/20; B60W 2520/14

(57) ABSTRACT

A method for parking a vehicle in a parking lot includes generating steering commands for the vehicle while in the lot based on an occupancy grid and plenoptic camera data. The occupancy grid indicates occupied areas and unoccupied areas around the vehicle and is derived from map data defining parking spots relative to a topological feature contained within the lot. The plenoptic camera data defines a plurality of depth maps and corresponding images that include the topological feature captured during movement of the vehicle. The steering command is generated such that the vehicle follows a reverse perpendicular path into one of the spots without entering an occupied area.

### TECHNICAL FIELD

The present disclosure relates to a system and method for reverse perpendicular parking a vehicle.

### BACKGROUND

Vehicles may include autonomous driving systems that include sensors for sensing objects external to the vehicle. These sensors (such as ultrasonic, RADAR, or LIDAR) may be expensive and/or inaccurate.

### SUMMARY

According to one embodiment, a method for parking a vehicle in a parking lot includes generating steering commands for the vehicle while in the lot based on an occupancy grid and plenoptic camera data. The occupancy grid indicates occupied areas and unoccupied areas around the vehicle and is derived from map data defining parking spots relative to a topological feature contained within the lot. The plenoptic camera data defines a plurality of depth maps and corresponding images that include the topological feature captured during movement of the vehicle. The steering command is generated such that the vehicle follows a reverse perpendicular path into one of the spots without entering an occupied area.

According to another embodiment, a vehicle includes a controller configured to generate steering commands for a vehicle in a parking lot. The steering commands are based on an occupancy grid indicating occupied and unoccupied areas around the vehicle and derived from map data defining parking spots relative to a topological feature of the lot, and plenoptic camera data defining depth maps and corresponding images including the topological feature such that the vehicle follows a reverse perpendicular path into one of the spots.

According to yet another embodiment, a method includes generating steering commands for a vehicle in a lot. The steering commands are based on an occupancy grid indicating occupied and unoccupied areas around the vehicle and derived from map data defining parking spots relative to a topological feature contained within the lot, and plenoptic camera data defining depth maps and corresponding images including the topological feature such that the vehicle follows a reverse perpendicular path into one of the spots without entering an occupied area.

### BRIEF DESCRIPTION OF THE DRAWINGS

FIG. 1 is a schematic illustration of an example vehicle.

FIG. 2 is a schematic diagram of a plenoptic camera.

FIG. 3 is a block diagram of an example reverse perpendicular parking system.

FIG. 4 is a data dependency diagram of the reverse perpendicular parking system.

FIG. 5 is an example occupancy map for a vehicle attempting to park in a parking lot.

FIG. 6 is an example control strategy for operating the reverse perpendicular parking system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Various embodiments of the present disclosure provide a system and method for the autonomous valet parking using plenoptic cameras, and specifically reverse perpendicular parking a vehicle. Generally, the valet parking system uses plenoptic cameras (also known as light field cameras) to obtain images external to a vehicle. Using those images, the vehicle can identify available parking spaces and control the vehicle to park in the available space. The parking system is configured to use a plenoptic camera to obtain images external to the vehicle and to generate depth maps and images of the surrounding area. After generating the depth maps and images, the plenoptic camera sends the depth maps to the vehicle controller. The depth maps enable the controller to determine the distance between the vehicle and objects surrounding the vehicle, such as curbs, pedestrians, other vehicles, and the like. The controller uses the received depth maps and images, and map data, to generate an occupancy grid. The occupancy grid divides the area surrounding the vehicle into a plurality of distinct regions and, based on data received from the plenoptic camera, classified each region as either occupied (e.g. by all or part of an object) or unoccupied. The controller then identifies a desired parking space in one of a variety of different manners and, using the occupancy map, controls the vehicle to navigate to, and park in the desired parking space by traveling through the unoccupied regions identified in the occupancy map.

Referring to FIG. 1, an example vehicle 20 includes a powerplant 21 (such as an engine and/or an electric machine) that provides torque to driven wheels 22 that propel the vehicle forward or backward. The propulsion may be controlled by a driver of the vehicle via an accelerator pedal or, in an autonomous (or semi-autonomous) driving mode, by a vehicle controller 50. The vehicle 20 includes a braking system 24 having disks 26 and calipers 28. (Alternatively, the vehicle could have drum brakes.) The braking system 24 may be controlled by the driver via the brake pedal or by the controller 50. The vehicle 20 also includes a steering system 30. The steering system 30 may include a steering wheel 32, a steering shaft 34 interconnecting the steering wheel to a steering rack 36 (or steering box). The front wheels 22 are connected to the steering rack 36 via tie rods 40. A steering sensor 38 may be disposed proximate the steering shaft 34 to measure a steering angle. The steering sensor 38 is configured to output a signal to the controller 50 indicating the steering angle. The vehicle 20 also includes a speed sensor 42 that may be disposed at the wheels 22 or in the transmission. The speed sensor 42 is configured to output a signal to the controller 50 indicating the speed of the vehicle. A yaw sensor 44 is in communication with the controller 50 and is configured to output a signal indicating the yaw of the vehicle 20.

The vehicle 20 includes a cabin having a display 46 in electronic communication with the controller 50. The display 46 may be a touchscreen that both displays information to the passengers of the vehicle and functions as an input. A person having ordinary skill in the art will appreciate that many different display and input devices are available and that the present disclosure is not limited to touchscreens. An audio system 48 is disposed within the cabin and may include one or more speakers for providing information and entertainment to the driver and/or passengers. The system 48 may also include a microphone for receiving inputs.

The vehicle 20 also includes a vision system for sensing areas external to the vehicle. The vision system may include a plurality of different types of sensors such as cameras, ultrasonic sensors, RADAR, LIDAR, and combinations thereof. In one embodiment, the vision system includes at least one plenoptic camera 52. In one embodiment, the vehicle 20 includes a single plenoptic camera 52 (also known as a light-field camera) located at a rear end of the vehicle. Alternatively, the vehicle 20 may include a plurality of plenoptic cameras located on several sides of the vehicle.

Plenoptic cameras have a series of focal points that allow the view point within an image to be shifted. Plenoptic cameras are capable of generating a depth map of the field of view of the camera and capturing images. A depth map provides depth estimates for pixels in an image from a reference viewpoint. The depth map is utilized to represent a spatial representation indicating the distance of objects from the camera and the distances between objects within the field of view. An example of using a light-field camera to generate a depth map is disclosed in U.S. Patent Application Publication No. 2015/0049916 by Ciurea et al., the contents of which are hereby incorporated by reference in its entirety. The camera 52 can detect, among other things, the presence of several objects in the field of view of the camera, generate a depth map and images based on the objects detected in the field of view of the camera 52, detect the presence of an object entering the field of view of the camera, and detect surface variation of a road surface and surrounding areas.

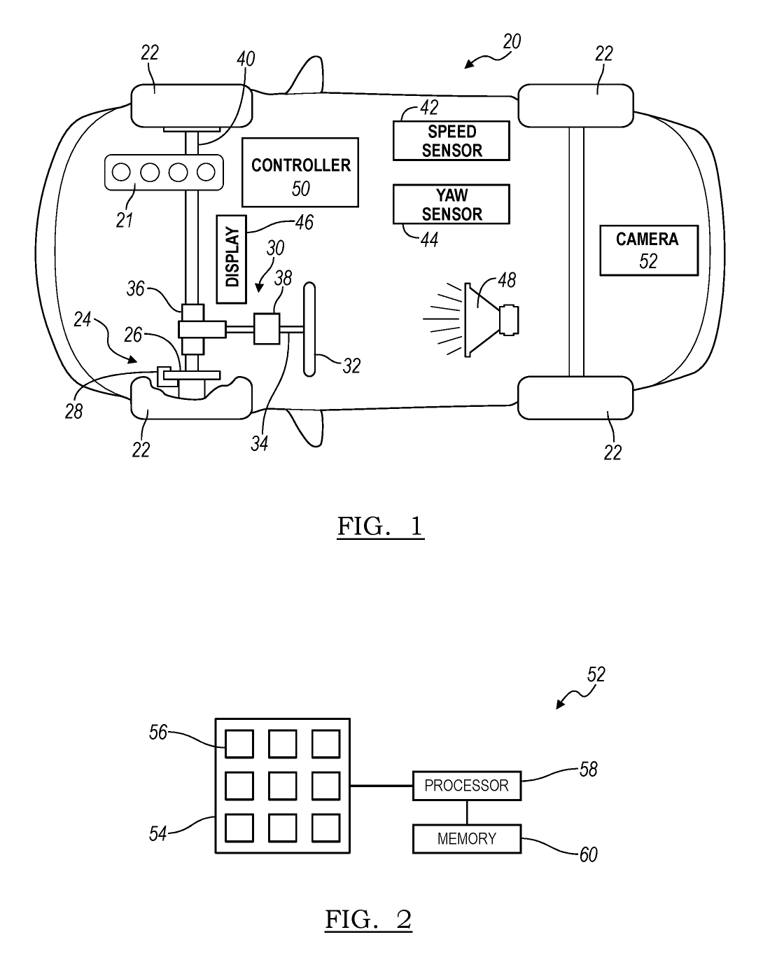

Referring to FIG. 2, the plenoptic camera 52 may include a camera module 54 having an array of imagers 56 (i.e. individual cameras) and a processor 58 configured to read out and process image data from the camera module 54 to synthesize images. The illustrated array includes 9 imagers, however, more or less imagers may be included within the camera module 54. The camera module 54 is connected with the processor 58. The processor is configured to communicate with one or more different types of memory 60 that stores image data and contains machine-readable instructions utilized by the processor to perform various processes, including generating depth maps.

Each of the imagers 56 may include a filter used to capture image data with respect to a specific portion of the light spectrum. For example, the filters may limit each of the cameras to detecting a specific spectrum of near-infrared light or of select portion of the visible light spectrum.

The camera module 54 may include charge collecting sensors that operate by converting the desired electromagnetic frequency into a charge proportional to the intensity of the electromagnetic frequency and the time that the sensor is exposed to the source. Charge collecting sensors, however, typically have a charge saturation point. When the sensor reaches the charge saturation point sensor damage may occur and/or information regarding the electromagnetic frequency source may be lost. To overcome potentially damaging the charge collecting sensors, a mechanism (e.g., shutter) may be used to proportionally reduce the exposure to the electromagnetic frequency source or control the amount of time the sensor is exposed to the electromagnetic frequency source. However, a trade-off is made by reducing the sensitivity of the charge collecting sensor in exchange for preventing damage to the charge collecting sensor when a mechanism is used to reduce the exposure to the electromagnetic frequency source. This reduction in sensitivity may be referred to as a reduction in the dynamic range of the charge collecting sensor, The dynamic range refers to the amount of information (bits) that may be obtained by the charge collecting sensor during a period of exposure to the electromagnetic frequency source.

The vision system is in electrical communication with the controller 50 for controlling the function of various components. The controller may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, a reference to “a controller” refers to one or more controllers. The controller 50 receives signals from the vision system and includes memory containing machine-readable instructions for processing the data from the vision system. The controller 50 is programmed to output instructions to at least a display 46, an audio system 48, the steering system 30, and the braking system 24, and the powerplant 21 to autonomously operate the vehicle.

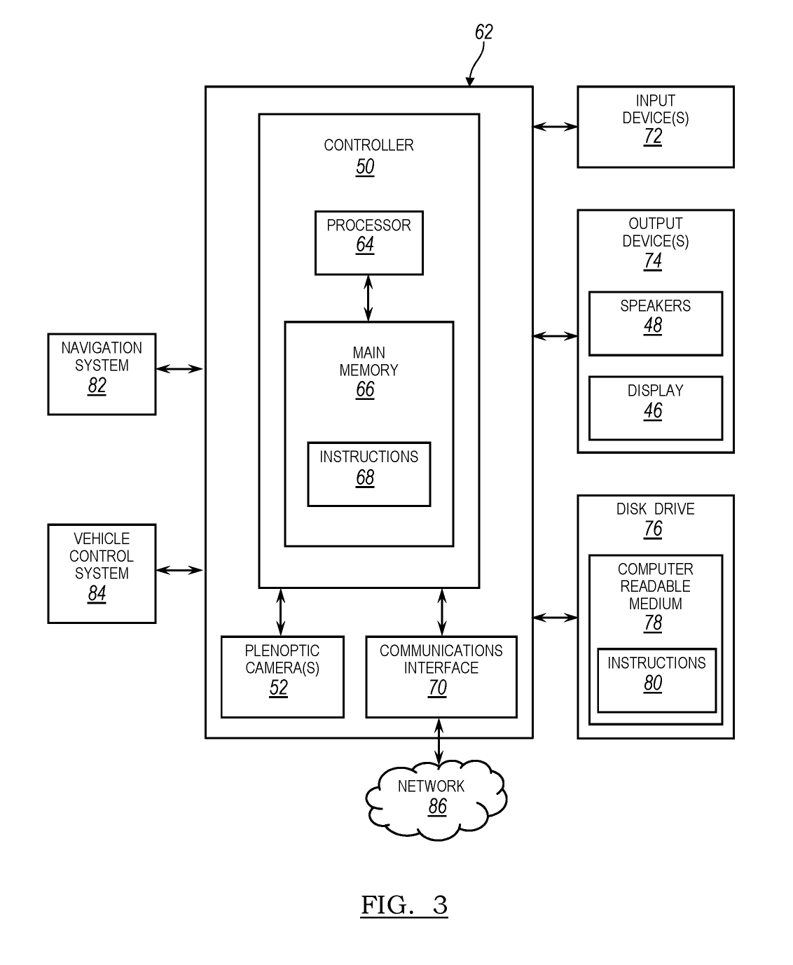

FIG. 3 illustrates an example of an autonomous parking system 62. The system 62 includes a controller 50 having at least one processor 64 in communication with the main memory 66 that stores a set of instructions 68. The processor 64 is configured to communicate with the memory 66, access the set of instructions 68, and execute the set of instructions 68 causing the parking system 62 to perform any of the methods, processes, and features described herein.

The processor 64 may be any suitable processing device or set of processing devices such as, a microprocessor, a microcontroller-based platform, a suitable integrated circuit, or one or more application-specific integrated circuits configured to execute the set of instructions 68. The main memory 66 may be any suitable memory device such as, but not limited to, volatile memory (e.g. RAM), non-volatile memory (e.g. disk memory, FLASH memory, etc.), unalterable memory (e.g. EPROMs), and read-only memory.

The system 62 includes one or more plenoptic cameras 52 in communication with the controller 50. The system 62 also includes a communications interface 70 having a wired and/or wireless network interface to enable communication with an external network 86. The external network 86 may be a collection of one or more networks, including standard-based networks (3G, 4G, Universal Mobile Telecommunications Systems (UMTS), GSM (R) Association, WiFi, GPS, Bluetooth and others) available at the time of filing of this application or that may be developed in the future. Further, the external network may be a public network, such as the Internet, or private network such as an intranet, or a combination thereof.

In some embodiments, the set of instructions 68, stored on the memory 66 and that are executable to enable functionality of the system 62, may be downloaded from an off-site server via the external network 86. Further, in some embodiments, the parking system 62 may communicate with a central command server via the external network 86. For example, the parking system 62 may communicate image information obtained by the cameras 52 to the central command server by controlling the communications interface 70 to transmit the images to the central command server via the network 86. The parking system 62 may also communicate any generated data maps to the central command server.

The parking system 62 is also configured to communicate with a plurality of vehicle components and vehicle systems via one or more communication buses. For example the controller 50 may communicate with input devices 72, output devices 74, a disk drive 76, a navigation system 82, and a vehicle control system 84. The input devices 72 may include any suitable input devices that enable a driver or passenger of the vehicle to input modification or updates to information referenced by the parking system 62. The input devices may include for example the control knob, an instrument panel, keyboard, scanner, a digital camera for image capture and/or visual command recognition, a touchscreen, audio input device, buttons, a mouse, or touchpad. The output devices 74 may include instrument cluster outputs, a display (e.g. display 46), and speakers (such as speakers 48).

The disk drive 76 is configured to receive a computer readable medium 78. The disk drive 76 receives the computer readable medium 78 on which one or more sets of instructions 80, such as the software for operating the parking system 62 can be embedded. Further, the instructions 80 may embody one or more of the methods or logic as described herein. The instructions 80 may reside completely, or at least partially, within any one or more of the main memory 66, the computer readable medium 78 and/or within the processor 64 during execution of the instructions by the processor.

While the computer-readable medium is shown to be a single medium, the term “computer-readable medium” includes a single medium or multimedia, such as a centralized or distributed database, and associated catches and servers that store one or more sets of instructions. The term “computer-readable medium” also includes any tangible medium that is capable of storing, encoding or carrying a set of instructions for execution by processor or the cause a computer to perform any one or more of the methods or operations described herein.

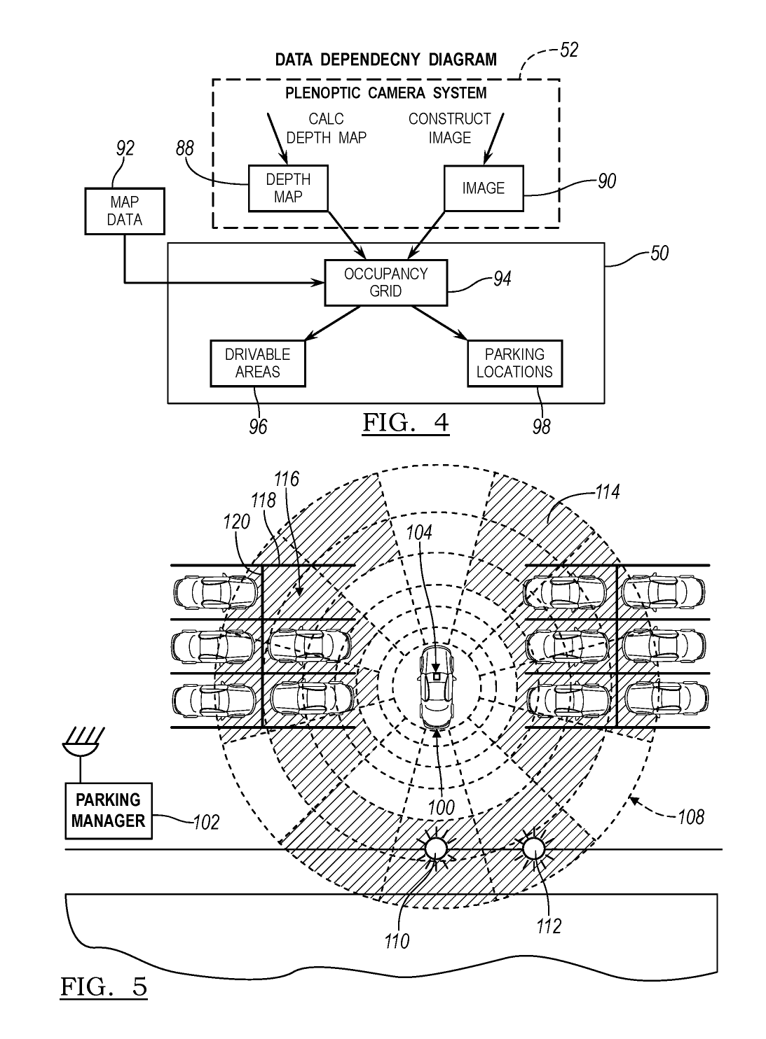

Referring to FIG. 4, the plenoptic camera 52 is configured to detect objects within its field of view and generate a depth map and an image of the field of view. The camera 52 periodically generates the depth maps 88 and images 90 creating a data stream of depth maps and images having a predefined frequency. The data stream is sent to the controller 50 for further processing. The controller 50 also receives map data 92 including a map that indicates features of a particular geographical area. The controller generates an occupancy grid 94 based on the data stream from the camera 52 and the map data 92. To generate the occupancy grid 94, the controller determines the location of the vehicle on the map 92 by comparing data obtained from the plenoptic camera 52 to identifiable features indicated on the map 92. Once the controller determines the vehicle's location on the map, the controller partitions areas surrounding the vehicle into regions or grids and determines a status for each of the regions. Example statuses include occupied or unoccupied. Occupied status indicates that an object is present within that region and that the vehicle cannot safely travel through that region. The controller analyzes the occupied and unoccupied regions to determine drivable areas 96 and parking locations 98.

FIG. 5 illustrates one example of generating a occupancy grid of a parking lot in which the vehicle 100 is attempting to park. The parking lot may have an associated parking manager 102 including a computer and transmitter for communicating with the vehicle 100. The parking manager 102 may transmit a map of the parking lot to the vehicle 100. The map includes topological features (e.g. curbs, buildings, trees, lights, guardrails, signs, monuments, road striping, and the like) and parking spots relative to the features. The map and parking lot may include artificial monuments (parking lot) and associated identifiers (map) that are used as identifiers to help the vehicle to locate itself on the map.

The vehicle 100 includes a one or more plenoptic cameras 104. In the illustrated embodiment, the vehicle 100 includes several plenoptic cameras providing 360° view surrounding the vehicle 100. As described above, the plenoptic cameras 104 capture images of this area surrounding the vehicle. Using this data, a vehicle controller 106 generates an occupancy grid 108. The light posts 110 and 112 may be some of the identifiable features used by the controller 106 to determine the position of the vehicle 100 on the map.

The occupancy grid 108 is partitioned into a plurality of zones or regions 114. Each zone 114 may have an individual status, such as occupied or unoccupied. The zones have an occupied status if an object is detected within at least a portion of the zone 114. The zones have an unoccupied status if objects are not present within the zones. Based on statuses of the zones, the controller is able to determine one or more drivable paths for the vehicle 100.

The driver of the vehicle 100, or the parking manager may choose the parking spot in which the vehicle 100 is going to park. In the illustrated example, the vehicle 100 is going to park in parking space 116 as it is the only remaining parking space available. Parking space 116 is delineated by a pair of side parking lines 118 and a front parking line 120. The parking lines may be included in the map data or may be populated onto the occupancy grid using the plenoptic cameras, which unlike RADAR sensors, are able to detect painted lines on the pavement. If the vehicle 100 is a fully autonomous vehicle, the vehicle may drive itself to space 116 and park itself automatically. Or the vehicle 100 may only be a semi-autonomous vehicle, in which case the driver will navigate the vehicle to parking space 116 at which point the vehicle will take over and autonomously or semi-autonomously reverse perpendicular park itself in space 116.

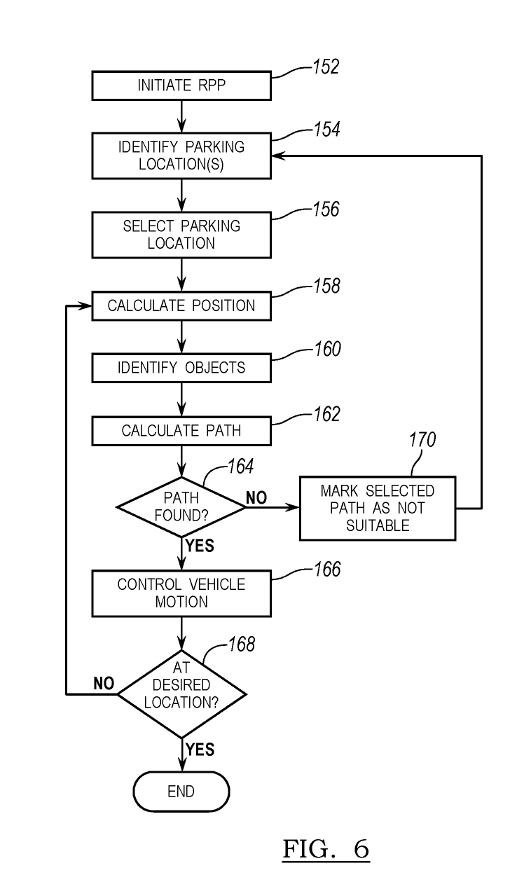

FIG. 6 is a control strategy for perpendicular parking a vehicle (such as vehicle 100). At operation 152 either the vehicle controller or the driver (or passenger) can request initiation of the reverse parallel parking system.

At operation 154 possible parking locations are identified. The parking locations may be identified by either the controller, by a driver of the vehicle, or assigned by a parking manager of the parking lot. In one embodiment, the controller identifies possible parking locations using the data supplied by the plenoptic camera.

At operation 156 one of the identified parking locations from operation 154 are selected to be the parking spot. The parking location may be selected by either the driver, or the vehicle controller. In one embodiment, a vehicle display shows possible parking locations to the driver, whom then chooses a parking spot via a user interface, such as a touchscreen. In another embodiment, the vehicle controller chooses the parking spot. The vehicle software may include a ranking algorithm that the controller uses in order to choose the parking spot.

At operation 158 the controller calculates a position of the vehicle. The position of the vehicle may be calculated as described above with reference to FIG. 5. At operation 160 the controller identifies objects using map data and/or camera data. The map data may be used to identify static objects such as curbs and light poles, and the camera may identify dynamic objects such as moving cars and pedestrians, as well as static objects such as parked car, curbs and light poles. The occupancy grid may be generated during operation 160 or may be generated prior to initiation of the parking system.

Once the parking spot is chosen, a path from the current vehicle location to the selected spot is calculated at operation 162. The path may be calculated using the occupancy grid. The vehicle's current location is known on the occupancy grid as is the selected parking spot. The controller is programmed with the driving constraints of the vehicle (such as turning radius, vehicle dimensions, ground clearance, and the like) and calculates a path, based on the driving constraints, through the unoccupied zones of the occupancy grid. The path includes both position information and velocity information. At operation 164 the controller determines if a path was found at operation 162. If at operation 162, the controller was unable to calculate a path, the path is marked as “unsuitable or the like” at operation 170, and control loops back to operation 154 and additional parking locations are identified. If a suitable path was found, control passes operation 166.

At operation 166 the controller generates steering, braking, and/or propulsion commands for the vehicle based on the calculated path to park the vehicle in the selected spot. Depending upon the embodiment the vehicle may automatically control both the steering, and the propulsion and braking, or may only control the steering and allow the driver to determine the appropriate propulsion and braking.

The steering, braking, and/or propulsion commands are based on an occupancy grid indicating occupied areas and unoccupied areas around the vehicle. The commands may be further based on map data defining parking spots relative to a topological feature contained within the lot, and plenoptic camera data defining a plurality of depth maps and corresponding images.

In one embodiment, the vehicle motion is controlled using position and orientation state estimates (POSE). It is reasonable to assume that the parking maneuver will be at low speeds well within the limits of tire adhesion. At low speeds, a relatively simple path-following controller can calculate the steering, powertrain, and brake-system inputs to make the vehicle follow a desired path. One such algorithm uses the heading error and lateral offset to calculate a desired vehicle-path curvature. For example, the path may be calculated using equation 1 below.

U_{κ}=κᵣ+k_{η}δ_{η}+k_{ψ}δ_{ψ} (1)

where U_{κ}=Commanded vehicle path curvature, κᵣ=Desired path curvature, k_{η}=Lateral path offset gain, δ_{η}=Lateral Path Offset, k_{ψ}=Heading error gain, and δ_{ψ}=Heading error.

Using the equation above, a commanded vehicle path curvature is calculated. At low speeds each steering wheel position produces a unique vehicle path curvature. The steering wheel position that corresponds to the commanded path curvature is sent to the vehicle steering system such as an Electrical Power Assist Steering (EPAS). The EPAS steering system uses an electric motor and positon control system to produce the desired steering wheel angle. Using these equations, the vehicle may be park in the selected spot without entering an occupied area of the occupancy grid.

For propulsion control, the vehicle position error along the path (δs) is used to calculate a commanded velocity (Uᵥ). Following a similar technique as above, equation 2 may be used to calculate Uᵥ.

Uᵥ=Vᵣ+kₛδₛ (2)

where Vᵣ=Desired path velocity, kₛ=Longitudinal path error gain, and δₛ=Longitudinal path error.

The commanded change in velocity is used to calculate commanded vehicle acceleration. The commanded vehicle acceleration is scaled by vehicle mass to calculate wheel torque. The wheel torque is produced by the vehicle powertrain and/or brake system. This applies to both conventional (gas), hybrid (gas electric) and electric vehicles.

At operation 168 the controller determines if the vehicle is at the desired location. If yes, the loop ends, if no, control passes back to operation 158 and the vehicle attempts to park the vehicle in the location selected at operation 156.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A method for parking a vehicle in a parking lot comprising:
receiving map data defining parking spots relative to a topological feature contained within the parking lot;
receiving plenoptic camera data, from a plenoptic camera, including a plurality of depth maps and corresponding images that include the topological feature captured during movement of the vehicle so that a sensed location of the vehicle within the parking lot is refined by comparing the topological feature of the map data with the images that include the topological feature; and
steering the vehicle while in the parking lot based on an occupancy grid indicating occupied areas and unoccupied areas around the vehicle, the occupancy grid being derived from the map data the plenoptic camera data, and the refinement such that the vehicle follows a reverse perpendicular path into one of the parking spots without entering an occupied area.

2. The method of claim 1 further comprising propelling the vehicle in the parking lot based on the occupancy grid such that the vehicle follows the reverse perpendicular path.

3. The method of claim 1 further comprising braking the vehicle in the parking lot based on the occupancy map such that the vehicle follows the reverse perpendicular path.

4. (canceled)

5. The method of claim 1 further comprising receiving the map data from a parking manger system associated with the parking lot.

6. A vehicle comprising:
a controller configured to:
receive map data defining parking spots relative to a topological feature contained within a parking lot;
receive plenoptic camera data including a plurality of depth maps and corresponding images that include the topological feature captured during movement of the vehicle so that a sensed location of the vehicle within the parking lot is refined by comparing the topological feature of the map data with the images that include the topological feature; and
execute steering of the vehicle in the parking lot based on an occupancy grid indicating occupied and unoccupied areas around the vehicle, the occupancy grid being derived from the map data, the plenoptic camera data, and the refinement such that the vehicle follows a reverse perpendicular path into one of the parking spots.

7. The vehicle of claim 6 further comprising a plenoptic camera mounted to the vehicle and configured to output the plenoptic camera data to the controller.

8. The vehicle of claim 6 further comprising a navigation system in communication with the controller and configured to receive the map data from a parking manger system associated with the parking lot.

9. The vehicle of claim 6 further comprising 1 further comprising a navigation system in communication with the controller and configured to receive the map data from a global positioning system.

10. The vehicle of claim 6 further comprising a steering system including a steering sensor configured to output a steering angle signal, wherein the controller is further configured to execute steering commands based of the steering angle signal.

11. The vehicle of claim 6 further comprising a powerplant and a vehicle speed sensor configured to output a speed signal, wherein the controller is further configured to propel the vehicle with the powerplant based on the occupancy grid and the speed signal such that the vehicle follows the reverse perpendicular path.

12. The vehicle of claim 6 further comprising a braking system, wherein the controller is further configured to operate the braking system based on the occupancy grid such that the vehicle follows the reverse perpendicular path.

13. The vehicle of claim 7 wherein the plenoptic camera further includes an array of imagers configured to capture images of objects within a field of view of the camera, and a processor configured to generate depth maps based on the images and to output the depth maps to the controller.

14. The vehicle of claim 11 wherein the powerplant is an engine or an electric machine.

15-20. (canceled)
